(19) United States
(12) Patent Application Publication
(10) Pub. No.: US 2024/0362051 A1
(43) Pub. Date: Oct. 31, 2024

(54) ENDPOINT MACHINE SOFTWARE CHANGE AUTOMATION PIPELINE

(71) Applicant: Dell Products L.P., Round Rock, TX (US)

(72) Inventors: Ahmed Elsayed Elshafey, New Cairo (EG); Ahmed Mohamed Hamed Zahran, New Cairo (EG); Sarah Tarek Ebeid AbdelAzeem, Giza (EG)

(21) Appl. No.: 18/307,150

(22) Filed: Apr. 26, 2023

(51) Int. Cl. G06F 9/455

(52) U.S. Cl. CPC G06F 9/45558; G06F 2009/45562; G06F 2009/45591

(57) ABSTRACT

One example method includes creating a virtual machine clone of a physical endpoint device, pushing a change script and a test script to the virtual machine clone, causing the change script to be executed on the virtual machine clone, causing the test script to be executed on the virtual machine clone, and correcting any problems identified by execution of the test script, and pushing the change script to the physical endpoint device, and causing the change script to be executed on the physical endpoint device.

### FIELD OF THE INVENTION

Embodiments of the present invention generally relate to installing and testing updates in a group of managed devices. More particularly, at least some embodiments of the invention relate to systems, hardware, software, computer-readable media, and methods, for using clones to test updates prior to deployment of the updates to production systems and devices.

### BACKGROUND

A large challenge in enterprise management is updating and generally changing software packages for devices being managed. There are many tools that assist with this process but there are currently no adequate measures to test changes and validate them. This often results in broken devices after the updates are installed, software performance issues, and other problems. This is something any user in an enterprise setting has likely experienced firsthand.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a pipeline for making a software change in one or more managed devices, according to one embodiment.

FIG. 2 discloses aspects of computing entity configured and operable to perform any of the disclosed methods, processes, and operations.

### DETAILED DESCRIPTION OF SOME EXAMPLE EMBODIMENTS

Embodiments of the present invention generally relate to installing and testing updates in a group of managed devices. More particularly, at least some embodiments of the invention relate to systems, hardware, software, computer-readable media, and methods, for using clones to test updates prior to deployment of the updates to production systems and devices.

In one embodiment, a pipeline is used to implement a software change in a group of managed devices. The pipeline may include various stages where different processes and functions are carried out. In an initial stage of the pipeline, metadata may be gathered concerning the hardware and software of the devices in which a software update is targeted for installation. Next, the metadata may be used to select OS (operating system) images and to create an autoinstall script that may be used to create VM (virtual machines) clones of the devices. A virtualization API (application program interface) may then be used to configure the VMs to create VM clones of the devices. The VM clones may be created using the metadata that was previously gathered. After the VM clones have been created, a change script and a test script may be created. The change script may be pushed out to the VM clones and executed on the VM clones. After the changes have been installed on the VM clones, the test script may be pushed out to the VM clones to test the changes that have been installed. If the testing is successful, the change may then be pushed out to the production devices, and if the testing is not successful, the testing results may be evaluated so that any problems can be corrected.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that problems with a software installation may be resolved before the software is installed on a production device. An embodiment may reduce, or eliminate, down time and other problems that can result when software is installed on a device. An embodiment may help to reduce or eliminate problems with installation of a software update across a population of dissimilar devices. An embodiment may enable assessment of the impact of a software installation on a particular device before the software is actually installed on that device. Various other advantages of one or more example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Context for Some Embodiments

The following is a discussion of aspects of various contexts and challenges relating to some example embodiments. This discussion is not intended to limit the scope of the invention, or the applicability of the embodiments, in any way.

An embodiment of the invention may overcome the problem of inadequate testing of software changes. Many users have experienced a situation where a software update ended up breaking some app or another after reboot. For example, Zoom® might hang, Chrome® may refuse to open with errors, or other cases. Such problems may make the user experience unsatisfactory, and may consume significant time to fix on an individual device basis using support tickets. These are example side effects that may be expected if these changes were tested only with so-called smoke tests. In this simplistic approach, a change can be tested on VMs or physical testing machines with a base OS corporate image and not on machines resembling, in any relevant way, the real endpoint devices. Thus, this approach, while relatively simple and quick to implement, would fail to give a good assessment of how the changes will impact real endpoints.

An embodiment of the invention may help to avoid situations where a disconnect occurs between testing, and deployment, processes. For example, if an admin wants to test an update and then push it out to a fleet of machines under management, the admin would likely need to have separate tools and environments for testing, and for sending out the updates to the machines. This disconnect makes the task much harder for the admin as it would require more time and has more moving parts. This approach also makes it so the admin cannot easily estimate the time it will take to go from testing to pushing out the updates, as the admin would need to trigger that process manually and updating a batch of machines would take a longer time than updating individual machines.

Another advantage of an embodiment of the invention is that it may reduce, or eliminate, the difficulties that may be involved in automating the testing of software on many machines at the same time. In such an approach, updates would be delivered to many machines at the same time, or in stages. Testing the impact of those updates over that number of machines may not be feasible because of the amount of manual work involved. This may compel IT admins to resort to other, inadequate, software testing methods.

Still another advantage of an embodiment relates to telemetry gathering and longer-term software update testing. By way of contrast with an embodiment, telemetry and feedback may be gathered after an update has been applied to user machines, which would require users to test unproven machines and cause possible interruptions, waste employee time, IT department overload, and overall frustration. In an embodiment, telemetry may be gathered, if at all, when the update is installed and run on a clone of a production device, and in this way, the testing and telemetry burden may be removed from the user.

### B. Overview

Suppose, hypothetically, that an admin is managing ten thousand Windows® laptop devices in an enterprise setting and needs to update Chrome® on all of those devices because of a vulnerability with the current version. This might be done, for example, by executing the update through a UEM solution (Unified Endpoint Management) like Microsoft® Insight or VMWare® Workspace One. Note that UEM refers to an IT software that may be used to manage endpoint devices, such as Windows® laptops for example.

Such an approach would enable the admin to choose which devices or groups will be updated. The admin would also want to get useful feedback for the change from the UEM, and have good recovery options in case of the failure of an update. However, the admin may not be sure how this change could impact the users. For example, the update may cause the users to lose their browser data, or Chrome® might refuse to open after the update, or any one of various other issues. Thus, the admin may want to test that update before pushing it to a production device so as to avoid that kind of damage and interruption. However, UEMs do not provide that kind of functionality so the admin would have to rely on some other approach.

For example, the admin might test the update on a testing laptop available for that purpose to see if it will work on the base OS image for the organization. The admin might also make sure to enable all the usual options that the UEM provides to help with the actual update, like staggering the roll to give time to get feedback and recover from errors. As well, the admin might make sure to have backups and rollback options in case the update causes issues as well. None of these though would give the admin a good idea of the risks and how the update would really impact the devices under management, or give the admin a guarantee of the ability to quickly recover from failures in a way that eliminates interruptions and other problems.

Approaches such as those just described may help the admin with reducing errors and recovering but what the admin really needs is a way to validate and test the updates better before pushing them out to the production devices. However, the use of base testing units does not enable this functionality. That approach assumes that all laptops, or other devices, under management are close enough to the base test unit in configuration, and also assumes that testing on one laptop for example, or a hundred, would provide a good indication of how the installation would proceed for the other devices in the population. That is evidently not the case however, as there will always be users who have errors on their individual machines. Most users have experienced the results of this firsthand with their production devices when Zoom®, Chrome®, or other software, continuously hangs and breaks after an update has been installed.

With these considerations in view, an embodiment of the invention may address the update testing challenge. An embodiment may include a system to make it easy to test changes on direct clones of each device being managed to provide the best indication possible of how the change would impact the real device. This may improve the management and support services provided to its customers by improving the ability to test and deliver on software changes and updates. This approach may also improve external services and IT operations by making it easier for IT admins and internal services business units to test updates pushed internally. This can be a time and resource save for the organization as a whole and would reduce sources of frustration for users and IT admins alike.

Thus, one particular embodiment comprises a change pipeline that may enable creation of a change script that executes the needed update, and pushes the update to repository. A CI/CD (continuous integration/continuous delivery) pipeline may test the update on VMs that match the managed devices and, once the tests pass, the pipeline may push the change to all the devices through an endpoint management software.

### C. Detailed Discussion

An embodiment of the invention may make it easier to solve existing problems with making software changes on a group of devices that may be dissimilar from each other. An embodiment may comprise an automated process that performs testing, validation, and deployment, automatically without affecting real endpoints or interrupting users. An embodiment may achieve this by cloning endpoints to VMs and using these VMs for testing software changes before pushing them out to the endpoints, or production devices. Updates may then be automatically pushed to each endpoint once the test for its corresponding VM clone has passed. An example approach for endpoint cloning to a VM is disclosed in Abdulaal, Omar & Elshafey, Ahmed & Ismail, Mahi, Endpoint Digital Twin Simulation System and U.S. patent application Ser. No. 17/980,724, titled “VIRTUAL REPRESENTATIONS OF ENDPOINTS IN A COMPUTING ENVIRONMENT”, filed 4 Nov. 2022, both publications of which are incorporated herein in their respective entireties.

Briefly however, a cloning process may comprise the following operations:
[1] collecting select pieces of metadata about each endpoint through a UEM API;
[2] creating OS images for each endpoint that uses the base OS for that endpoint and packs installed software and configurations in the OS image;
[3] creating a VM using the OS image through vSphere API; and
[4] controlling and making changes to the VM through a UEM client preinstalled in the OS image alongside other software.

The full process for creating VM clones along with testing, validating, and deploying changes is fully automated once triggered. Its simplest implementation is as part of a task pipeline that executes the different stages sequentially. The structure of some example pipeline stages is discussed hereafter.

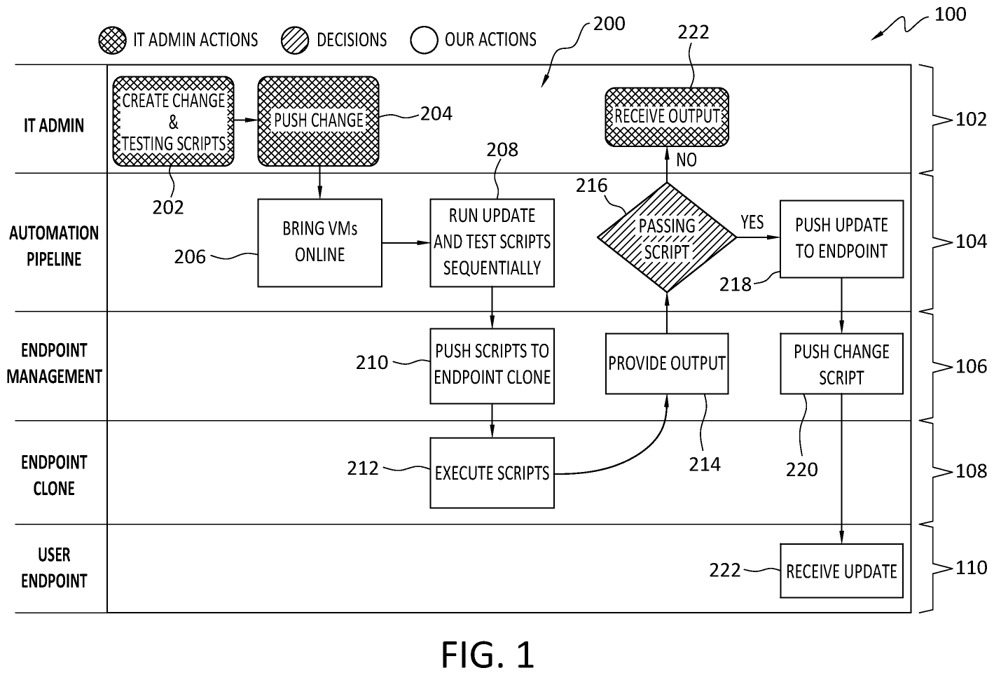

Turning now to FIG. 1, the structure of an example architecture 100 and associated operations, according to one embodiment, is disclosed. As shown, the architecture 100 may be considered as comprising various layers that relate in some way to each other. One or more of the layers may comprise, or take the form of, a pipeline of some type. As indicated in the legend, various operations or actions may be taken by an IT admin, some actions may be part of an example embodiment, and various decision points may be involved that may guide the performance of certain functions.

An uppermost layer 102 may correspond to an IT admin, and may comprise various functions performed by, or at the direction of, the IT admin. Example functions, discussed in more detail below, may comprise creating change and testing scripts, pushing software changes to VM clones, and receiving information about the execution of scripts on the VM clones.

The next layer 104 may comprise an automation pipeline that may comprise automatic performance of various functions. Such functions may include, for example, bringing VM clones online, running update and test scripts on the VM clones, checking scripts for satisfactory execution, and pushing software updates to endpoint devices.

The layer 106 may involve management of the endpoint devices where the software updates are to be installed. Thus, functions performed in the layer 106 may include pushing update and test scripts to VM clones, providing the output of executed scripts to a recipient, and pushing change scripts to VM clones.

The next layer 108 may comprise one or more VM clones and may relate to the performance of functions relating to the VM clones. Particularly, update and test scripts may be executed in the layer 108.

The final layer 110 may concern the endpoint devices. Particularly, the final layer 100 may comprise endpoint devices that receive the updates after the updates have been tested on the VM clones that correspond to those endpoint devices.

### C.1 Stages of an Example Embodiment

With continued reference to the architecture 100 disclosed in FIG. 1, an embodiment of the invention may comprise various stages, that may include one or more of the functions disclosed in FIG. 1. It is noted that the functional allocation disclosed in FIG. 1 is provided by way of example, and is not intended to limit the scope of the invention. Thus, the functions disclosed in FIG. 1 may be allocated differently in other embodiments.

### C.1.1 Gather Endpoint(s) Metadata and Configuration

As a prerequisite to initiation, by an admin for example, of the functions in layer 102, a method according to one embodiment may gather metadata concerning the endpoint devices where an update, such as a software update, is to be installed. The metadata may comprise metadata about the hardware specs, the OS, and the software installed, along with versioning information, about the endpoint devices.

### C.1.2 Create OS Images and VMs for Endpoint(s)

At this stage, the metadata about the endpoint devices may used to select an OS image for a VM clone, and to create an autoinstall script, and/or pack the OS image. These components may then be used to create the VM clones with the same hardware specs, and the OS and software versions may be used to create the autoinstall script, which may be used to auto install, on the VM clone, the OS and the software specified afterwards.

### C.1.3 Virtualization API to Create Machine Clones with the Different Images

A virtualization application may then be used to create the VM clones, which may include their different respective OS images. In an embodiment, the API of VMware vSphere® may be used to create VM clones of the machines, with the machine specification metadata gathered earlier, by invoking Create VM API (Accessing Programming Interface) in vSphere. The system uses existing VMs for each endpoint or creates new VMs for ones that do not exist yet.

C.1.4 Create Change and Test Scripts

After the VM clones have been created that correspond to the respective production devices, testing of a software update or other change may be performed. To this end, and with reference now to the method 200 disclosed in FIG. 1, when there is a change that is to be tested, a change script and a test script may be created 202. In general, and as discussed below, the change script may be executed to install the software change on a VM, and the test script may be used to test the operation of the installed software change.

After the VMs clones are created, and the change script, also referred to herein as an ‘update script,’ and test script written, an admin may push 204 the change script and the test script to an automation pipeline. In the automation pipeline, the VM clones may then be brought online 206, and the change script, and test script, may then be run sequentially 208 on the VM clones to install the new change.

In an embodiment, the following message may be provided to the IT admin:

“The outputs of both the change and test scripts are provided to you for viewing. Should there be an error in either the change or the test script, the process halts. If both the scripts pass, the final step is to execute the change script on the original endpoint. In the end of this process, you will have tested and made the change to each of your endpoints without manual effort on your part beyond creating the change and test scripts.”

### C.1.5 Push and Execute the Change Script

The running 208 of the change script may comprise pushing 210, such as by a Unified Endpoint Management, such as UEM GRR Rapid Response, running in an endpoint management layer, the change script and the test script to a VM clone. The change script may be executed 212 in the VM clone of the endpoint device.

### C.1.6 Push and Execute the Test Script

If the change script runs on the VM clone without error, then the test script may be pushed 210 to the VM clone and executed 212 on the VM clone to validate the installations against the validation framework. Based on output generated 214 as a result of the execution of the test script, various actions may be taken.

### C.1.7 in Case of Successful Testing, Automatically Push to Real Endpoint

If it is determined at 216, based on the output 214, that the test script has passed, that is, performed without identifying any problems, the update may be automatically pushed 218, such as by using the UEM, from the VM clone to the corresponding physical endpoint device. In more detail, the change script may be pushed 220 to, and received 222 by, the physical endpoint device.

### C.1.8 in Case of Failure, Get the Error Output and Evaluate

If it is determined at 216 that execution of the test script resulted in an error, the error and associated information may be communicated to, and received 224, by the IT admin team for investigation and resolution.

### D. Further Discussion

As will be apparent from this disclosure, embodiments of the invention may possess various useful features and aspects. For example, an embodiment may automate change testing and validation for an arbitrary number of endpoint machines, which may be dissimilar to each other in terms of their physical and/or software configurations, without any side effects on those endpoint machines. Because that validation may be performed on VM clones of the endpoints, and not on the endpoints themselves, the validation process may have zero side effects on the endpoint machines in case of any failures and can be scaled to any size of endpoint fleets.

As another example, an embodiment may provide automated test validation and deployment. In particular, an embodiment may deploy, in a fully automated way, changes to real endpoints under management in response to test validation success and part of the same testing pipeline. The process for deploying changes may be part of the same testing environment and pipeline, thus removing deployment uncertainty and effort.

As a final example, an embodiment may provide automated telemetry gathering for testing devices. For example, graphs of the resource utilization (CPU, memory, network bandwidth, and storage, for example) that represent the aggregate utilization over all testing VMs may be provided through UEM clients installed on the VMs. These graphs may indicate the utilization of the resources before, and after, the change has been installed on an endpoint device, and may enable an admin to easily see if there are increases in resource utilization after the change, offering some insight into the impact of the change on endpoint devices where the change has been installed.

### E. Aspects of an Example Use Case

Suppose that an admin wants to change Linux® CLI packages. Particularly, the admin wished to update Docker® to the latest LTS version on all Linux® endpoints under management. In this case, the following change, or update, script might be used to implement make the update:

#!/bin/bash
sudo apt-get install docker-ce=5:20.10.13~3-0~ubuntu-jammy

Then the admin may perform some simple testing for the update, such as with the following script:

```
#!/bin/bash
if [[ $(sudo docker version | grep -Fxq “5:20.10.13”) ]]
then
else
  echo “ERROR: docker version incorrect”
  return 1
fi
sudo docker run hello-world
if [[ $(sudo docker ps | grep -Fxq “hello-world”) ]]
then
    return 0
else
  echo “ERROR: docker didn't create hello world container”
  return 1
fi
# .... Other tests for usage and validation as desired
```

Both of these scripts may be provided to the pipeline, which may then automatically follow through the process to completion. Having this tested on clones of each of the physical endpoints makes that test more solid as the clones represent the actual system where the update will be made. Thus, a user may only have to create the change script and the test script, and an embodiment of the invention may take any and all further required actions to implement deployment of the change on the endpoint devices.

### F. Example Methods

It is noted with respect to the disclosed methods, including the example method of FIG. 1, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. Further Example Embodiments

Following are some further example embodiments of the invention. These are presented only by way of example and are not intended to limit the scope of the invention in any way.

Embodiment 1. A method, comprising: creating a virtual machine clone of a physical endpoint device; pushing a change script and a test script to the virtual machine clone; causing the change script to be executed on the virtual machine clone; causing the test script to be executed on the virtual machine clone, and correcting any problems identified by execution of the test script; and pushing the change script to the physical endpoint device, and causing the change script to be executed on the physical endpoint device.

Embodiment 2. The method as recited in any preceding embodiment, wherein creating the virtual machine clone is performed using metadata about a configuration of the physical endpoint device.

Embodiment 3. The method as recited in any preceding embodiment, wherein respective virtual machine clones are created for each physical endpoint device in a group of physical endpoint devices, and the physical endpoint devices in the group differ from each other in terms of their software configuration and/or their hardware configuration.

Embodiment 4. The method as recited in any preceding embodiment, wherein creating the virtual machine clone comprises creating an OS (operating system) image.

Embodiment 5. The method as recited in any preceding embodiment, wherein the change script is automatically pushed to, and installed on, the physical endpoint device after the change script and the test script have been successfully executed on the virtual machine clone.

Embodiment 6. The method as recited in any preceding embodiment, wherein any problems resulting from execution of the change script are corrected before the test script is executed.

Embodiment 7. The method as recited in any preceding embodiment, wherein the change script is never executed on the physical endpoint device until after the change script has been pushed to the physical endpoint device.

Embodiment 8. The method as recited in any preceding embodiment, wherein telemetry is collected automatically from the physical endpoint device both before, and after, execution of the change script on the physical endpoint device.

Embodiment 9. The method as recited in any preceding embodiment, wherein the physical endpoint device is unaffected by execution of the change script and the test script on the virtual machine clone.

Embodiment 10. The method as recited in any preceding embodiment, wherein the change script is pushed to a group of physical endpoint devices after successful execution of the test script and the change script on virtual machine clones respectively corresponding to physical endpoint devices in the group, and the physical endpoint devices in the group differ from each other in terms of their software configuration and/or their hardware configuration.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

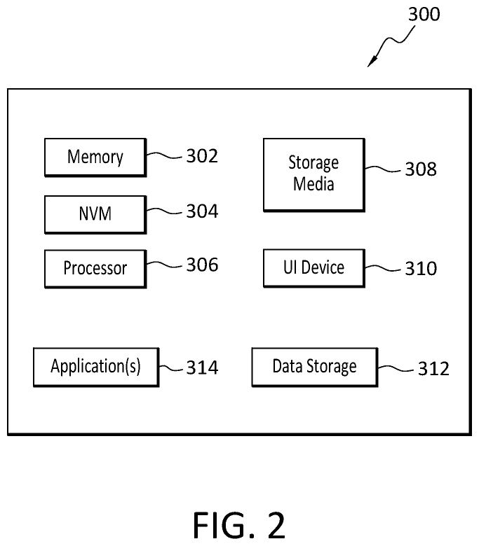

With reference briefly now to FIG. 2, any one or more of the entities disclosed, or implied, by FIG. 1, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 2.

In the example of FIG. 2, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
creating a virtual machine clone of a physical endpoint device;
pushing a change script and a test script to the virtual machine clone;
causing the change script to be executed on the virtual machine clone;
causing the test script to be executed on the virtual machine clone, and correcting any problems identified by execution of the test script; and
pushing the change script to the physical endpoint device, and causing the change script to be executed on the physical endpoint device.

2. The method as recited in claim 1, wherein creating the virtual machine clone is performed using metadata about a configuration of the physical endpoint device.

3. The method as recited in claim 1, wherein respective virtual machine clones are created for each physical endpoint device in a group of physical endpoint devices, and the physical endpoint devices in the group differ from each other in terms of their software configuration and/or their hardware configuration.

4. The method as recited in claim 1, wherein creating the virtual machine clone comprises creating an OS (operating system) image.

5. The method as recited in claim 1, wherein the change script is automatically pushed to, and installed on, the physical endpoint device after the change script and the test script have been successfully executed on the virtual machine clone.

6. The method as recited in claim 1, wherein any problems resulting from execution of the change script are corrected before the test script is executed.

7. The method as recited in claim 1, wherein the change script is never executed on the physical endpoint device until after the change script has been pushed to the physical endpoint device.

8. The method as recited in claim 1, wherein telemetry is collected automatically from the physical endpoint device both before, and after, execution of the change script on the physical endpoint device.

9. The method as recited in claim 1, wherein the physical endpoint device is unaffected by execution of the change script and the test script on the virtual machine clone.

10. The method as recited in claim 1, wherein the change script is pushed to a group of physical endpoint devices after successful execution of the test script and the change script on virtual machine clones respectively corresponding to physical endpoint devices in the group, and the physical endpoint devices in the group differ from each other in terms of their software configuration and/or their hardware configuration.

11. A non-transitory storage medium having stored therein instructions that are executable by one or more hardware processors to perform operations comprising:
creating a virtual machine clone of a physical endpoint device;
pushing a change script and a test script to the virtual machine clone;
causing the change script to be executed on the virtual machine clone;
causing the test script to be executed on the virtual machine clone, and correcting any problems identified by execution of the test script; and
pushing the change script to the physical endpoint device, and causing the change script to be executed on the physical endpoint device.

12. The non-transitory storage medium as recited in claim 11, wherein creating the virtual machine clone is performed using metadata about a configuration of the physical endpoint device.

13. The non-transitory storage medium as recited in claim 11, wherein respective virtual machine clones are created for each physical endpoint device in a group of physical endpoint devices, and the physical endpoint devices in the group differ from each other in terms of their software configuration and/or their hardware configuration.

14. The non-transitory storage medium as recited in claim 11, wherein creating the virtual machine clone comprises creating an OS (operating system) image.

15. The non-transitory storage medium as recited in claim 11, wherein the change script is automatically pushed to, and installed on, the physical endpoint device after the change script and the test script have been successfully executed on the virtual machine clone.

16. The non-transitory storage medium as recited in claim 11, wherein any problems resulting from execution of the change script are corrected before the test script is executed.

17. The non-transitory storage medium as recited in claim 11, wherein the change script is never executed on the physical endpoint device until after the change script has been pushed to the physical endpoint device.

18. The non-transitory storage medium as recited in claim 11, wherein telemetry is collected automatically from the physical endpoint device both before, and after, execution of the change script on the physical endpoint device.

19. The non-transitory storage medium as recited in claim 11, wherein the physical endpoint device is unaffected by execution of the change script and the test script on the virtual machine clone.

20. The non-transitory storage medium as recited in claim 11, wherein the change script is pushed to a group of physical endpoint devices after successful execution of the test script and the change script on virtual machine clones respectively corresponding to physical endpoint devices in the group, and the physical endpoint devices in the group differ from each other in terms of their software configuration and/or their hardware configuration.
